(19) United States
(12) Patent Application Publication
(10) Pub. No.: US 2018/0322988 A1
(43) Pub. Date: Nov. 8, 2018

(54) HIGH VOLTAGE TAPING TOOL AND METHOD

(71) Applicant: Michael THOMPSON, Loudonville, OH (US)

(72) Inventor: Michael THOMPSON, Loudonville, OH (US)

(21) Appl. No.: 15/589,254

(22) Filed: May 8, 2017

(51) Int. Cl. H01B 13/26; B29C 65/50; B29C 65/00; B29C 73/24

(52) U.S. Cl. CPC H01B 13/2613; B29C 65/50; B29L 2031/3462; B29C 66/87; B29C 73/24; B29C 66/83411

(57) ABSTRACT

A tool usable for working on high voltage lines including a hot stick and a tape dispenser attached to or incorporated in or on the hot stick. In some aspects, the hot stick further comprises an angle arm that may facilitate application of tape to the high voltage line. An attachment between the hot stick and the tape dispenser may be included and may also include such an angle arm. One or more index notched may be included to facilitate alignment of the tape dispenser. A cutter for the tape may be included. Also, associated methods.

### BACKGROUND

The present disclosure generally relates to high voltage taping tools and methods.

### SUMMARY

Aspects of the subject technology include a tool usable for working on high voltage lines including a hot stick and a tape dispenser attached to or incorporated in or on the hot stick. In some aspects, the hot stick further comprises an angle arm that may facilitate application of tape to the high voltage line. An attachment between the hot stick and the tape dispenser may be included and may also include such an angle arm. One or more index notched may be included to facilitate alignment of the tape dispenser. A cutter for the tape may be included. The subject technology also includes associated methods.

This brief summary has been provided so that the nature of the invention may be understood quickly. Additional steps and/or different steps than those set forth in this summary may be used. A more complete understanding of the invention may be obtained by reference to the following description in connection with the included drawings.

### BRIEF DESCRIPTION OF THE DRAWINGS

FIG. 1 illustrates a hot stick and tape dispenser according to possible aspects of the subject technology.

FIG. 2 illustrates a hot stick, tape dispense, and tape cutter according to possible aspects of the subject technology.

FIGS. 3 and 4 illustrate further possible aspects of the subject technology that may be used to attach or incorporate a tape dispenser in or on a hot stick.

FIG. 5 illustrates an attaching member between a hot stick and a tape dispenser according to possible aspects of the subject technology.

FIG. 6 illustrates additional possible aspects of a tape dispense and associated elements that may be attached to or incorporated in or on a hot stick according to the subject technology.

FIG. 7 illustrates methods according to possible aspects of the subject technology.

### DETAILED DESCRIPTION

Briefly, aspects of the subject technology may include a tool usable for working on high voltage lines including a hot stick and a tape dispenser attached to or incorporated in or on the hot stick. In some aspects, the hot stick further comprises an angle arm that may facilitate application of tape to the high voltage line. An attachment between the hot stick and the tape dispenser may be included. The attachment may include such an angle arm. One or more index notched may be included to facilitate alignment of the tape dispenser. A cutter for the tape may be included. The subject technology also includes associated methods.

In more detail, working on high voltage lines, for example but not limited to ones of over 110,000 volts, is extremely dangerous. A small mistake can instantly lead to serious injuries or death.

For this and other reasons, a “hot stick” is typically used to disconnect and/or otherwise manipulate high voltage lines before, during, or after repairs. A hot stick typically is an insulated pole usually made of fiberglass used by electric utility workers when working on energized high voltage power lines to protect them from electrocution. See, e.g., Cadick, John; Mary Capelli-Schellpfeffer; Dennis Neitzel (2005); Electrical Safety Handbook. USA: McGraw-Hill Professional. pp. 2.44-2.48. ISBN 0-07-145772-0. The subject technology is not limited to hot sticks made of fiberglass or as otherwise described above or in the Electrical Safety Handbook.

Sometimes tape, for example but not limited to plastic and/or rubber possibly with adhesive, needs to be applied to energized high voltage lines and connections. For example, after a significant weather event such as hail, high winds, or tornadoes, insulation on and/or connections to high voltage lines may be damaged while the power lines are still otherwise functional. In these contexts, cutting power to permit repair without risks associated with energized high voltage is not an optimal course of action because doing so may cost lives. For example, depriving power from civilians, hospitals, first responders, military facilities, and other critical infrastructure may also result in serious injuries or death.

Aspects of the subject technology are believed to significantly reduce workers' risks of electrocution when applying tape to energized high voltage lines. Furthermore, use of conventional hot sticks and prior art attachments not specifically designed for application of tape can be cumbersome. Therefore, workers sometimes simply take other measures out of frustration or impatience, which can result and has in fact resulted in serious injuries and death. Aspects of the subject technology attempt to address this issue.

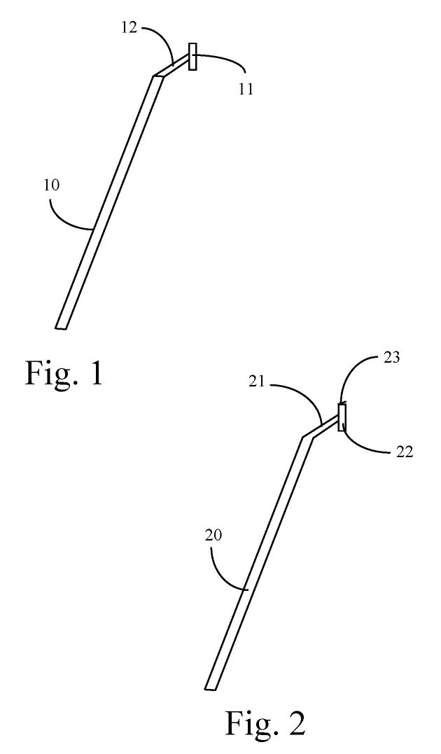

FIG. 1 illustrates a hot stick with a tape dispenser according to possible aspects of the subject technology. Hot stick 10 is attached to tape dispenser 11 via angle arm 12. In this figure, the angle arm is a separate item attached to the hot stick. However, the angle arm need not be a separate item. Inclusion of an angle arm is preferred because it may facilitate application of tape to high voltage lines, but is not mandatory.

In FIG. 2, hot stick 20 includes an attachment in the form of angle arm 21 to tape dispense 22. Cutter 23 for the tape is also shown. Such a cutter may be included or omitted from any of the arrangements disclosed herein.

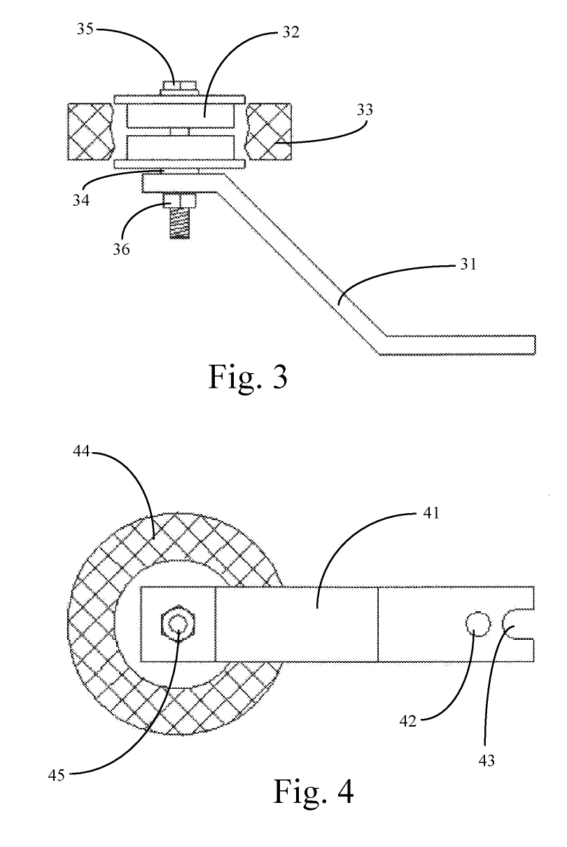

FIGS. 3 and 4 illustrate further possible aspects of the subject technology that may be used to attach or incorporate a tape dispenser in or on a hot stick. In FIG. 3, angle arm 31 is attached to or includes tape dispenser(s) 32 with tape 33 via connection 34. The illustrated connection comprises a bolt secure by nuts 35 and 36. Any other form of connection may be used.

Two tape dispensers are shown in FIG. 3. Any number of tape dispensers may be included, for example to facilitate application of multiple rolls of tape without having to re-load the dispenser(s).

FIG. 4 is a top view of possible aspects shown in FIG. 3. In this figure, attachment 41 includes location and/or secure point 42 and slot 43, which may be used to secure the attachment to a hot stick. For example, a bolt, pin, screw, or any other element may pass through location and/or secure point 32. Also shown are tape to be dispensed 44 and connection 45 to a tape dispenser.

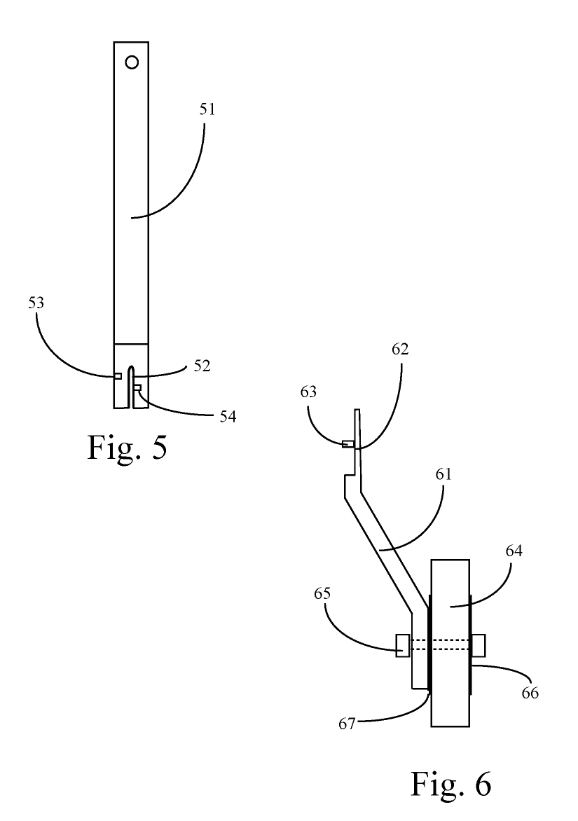

FIGS. 5 and 6 illustrate additional possible aspects of the subject technology. FIG. 5 illustrates an attaching member between a hot stick and a tape dispenser, and FIG. 6 illustrates additional aspects of a tape dispense and associated elements that may be attached to or incorporated in or on a hot stick.

In FIG. 5, attachment 51 for a tape dispenser to a hot stick includes slot 52 that may facilitate alignment. Also included are index notches 53 and 54, one inside the slot and one outside the slot. None, one, two, or more of such slots and/or notches may be included. The notches may match a pin or the like provided on a tape dispenser or attachment to such.

For example, FIG. 6 shows attachment 61 with flange 62 that may fit into slot 52 or may be positioned alongside attachment 51. Pin 63 may fit into index notches 53 or 54. This arrangement may facilitate proper alignment and/or attachment of attachment 61 to a hot stick for safe and efficient deployment of tape from tape dispenser 64. The tape dispenser may be secured via bolts and nuts 65 or the like. Pins, screws, or any other elements may also be used to secure the tape dispenser.

Also shown in FIG. 6 are optional discs 66 and 67 that may facilitate rotation of tape dispense 64. The discs may be omitted, and/or other elements may be included to facilitate such rotation.

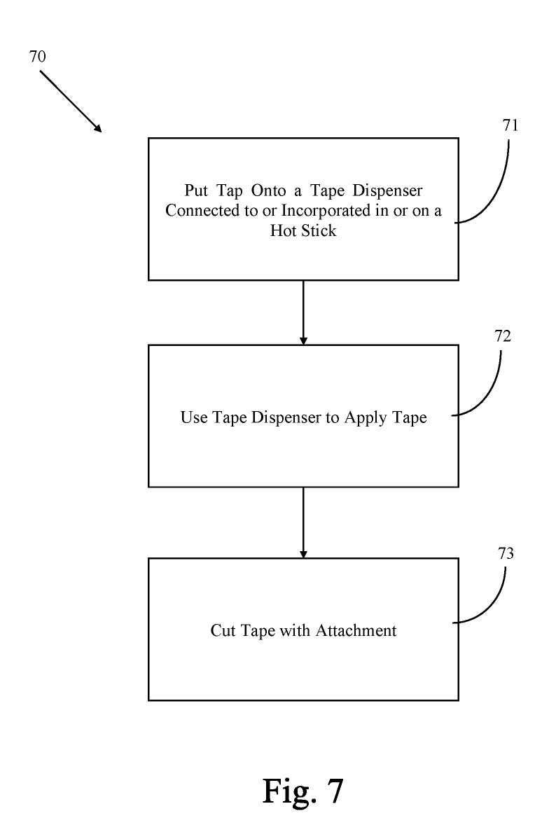

FIG. 7 illustrates methods 70 according to possible aspects of the subject technology. In step 71, tape is put onto a tape dispenser attached to or incorporated in or on a hot stick. Tape is applied in step 72. In optional step 73, the tape is cut using a cutter such as the one depicted in FIG. 2. Additional steps involving aspects of the subject technology discussed above may also be performed.

The invention is in no way limited to the specifics of any particular embodiments and examples disclosed herein. For example, the terms “aspect,” “example,” “preferably,” “alternatively,” and the like denote features that may be preferable but not essential to include in some embodiments of the invention. In addition, details illustrated or disclosed with respect to any one aspect of the invention may be used with other aspects of the invention. Additional elements and/or steps may be added to various aspects of the invention and/or some disclosed elements and/or steps may be subtracted from various aspects of the invention without departing from the scope of the invention. Singular elements/steps imply plural elements/steps and vice versa. Some steps may be performed serially, in parallel, in a pipelined manner, or in different orders than disclosed herein. Many other variations are possible which remain within the content, scope, and spirit of the invention, and these variations would become clear to those skilled in the art after perusal of this application.

What is claimed is:

1. A tool usable for working on a high voltage line comprising:
a hot stick; and
a tape dispenser attached to or incorporated in or on the hot stick.

2. A tool as in claim 1, wherein the hot stick further comprises an angle arm.

3. A tool as in claim 2, wherein the angle arm facilitates application of tape to the high voltage line.

4. A tool as in claim 1, wherein the hot stick further comprises an index notch for alignment of the tape dispenser.

5. A tool as in claim 1, further comprising an attachment between the hot stick and the tape dispenser.

6. A tool as in claim 5, wherein the attachment further comprises an angle arm.

7. A tool as in claim 6, wherein the angle arm facilitates application of tape to the high voltage line.

8. A tool as in claim 5, wherein the attachment further comprises an index notch for alignment of the tape dispenser.

9. A tool as in claim 1, further comprising a cutter for the tape.

10. A method of applying tape to a high voltage line comprising:
putting tape onto a tape dispenser attached to or incorporated in or on a hot stick;
using the tape dispenser to apply the tape to the high voltage line.

11. A method as in claim 10, wherein the hot stick further comprises an angle arm.

12. A method as in claim 11, wherein the angle arm facilitates application of tape to the high voltage line.

13. A method as in claim 10, wherein the hot stick further comprises an index notch for alignment of the tape dispenser.

14. A method as in claim 10, further comprising an attachment between the hot stick and the tape dispenser.

15. A method as in claim 14, wherein the attachment further comprises an angle arm.

16. A method as in claim 15, wherein the angle arm facilitates application of tape to the high voltage line.

17. A method as in claim 14, wherein the attachment further comprises an index notch for alignment of the tape dispenser.

18. A method as in claim 10, further comprising a cutter for the tape.
